(19) United States
(12) Patent Application Publication
(10) Pub. No.: US 2025/0084968 A1
(43) Pub. Date: Mar. 13, 2025

(54) SYSTEMS ENHANCING SAFETY UTILIZING PASSIVE PHOTOLUMINESCENT COMPONENTS

(71) Applicant: Tutaya Murchison, Fort Stewart, GA (US)

(72) Inventor: Tutaya Murchison, Fort Stewart, GA (US)

(21) Appl. No.: 18/828,380

(22) Filed: Sep. 9, 2024

Related U.S. Application Data
(60) Provisional application No. 63/631,998, filed on Apr. 10, 2024.
(60) Provisional application No. 63/537,200, filed on Sep. 8, 2023.

(51) Int. Cl. F21K 2/08; G08B 7/06

(52) U.S. Cl. CPC F21K 2/08; G08B 7/066

(57) ABSTRACT

An electronic light emitting system with a system integrated photoluminescent component includes an electric emitter, an actuator, a power source, a conductive pathway, and the photoluminescent component. The conductive pathway conveying current to the electric emitter from the power source when the actuator is in an on state and when the electronic emitter is active. When the electronic light emitting system is inactive and the electronic emitter is not emitting light, current does not flow along the conductive pathway and no responsive electromagnetic field is generated. When the electronic light system is inactive a proximate environment is an overly dark one, posing safety concerns to humans. The photoluminescent component is charged when the electric light emitting system is active. When the electric light emitting system is inactive, the photoluminescent component emits light without generating an electromagnetic field. Light emissions from the photoluminescent component lessen the safety concerns.

### CROSS-REFERENCE TO RELATED APPLICATIONS

The present application claims priority under 35 USC 119(e) to U.S. Provisional Application No. 63/631,998 filed Apr. 10, 2024, and U.S. Provisional Application No. 63/537,200 filed Sep. 8, 2023, the entire contents of which are incorporated by reference.

### FIELD OF THE EMBODIMENTS

The field of the invention and its embodiments relate to functional utilizations, beyond aesthetic ones, of glow-in-the-dark or passive photoluminescent products or components. More specifically, the field of the invention and its embodiments relate to systems that utilize characteristics, such as discharge duration, thermally related discharges, and light discharges that do not generate a potentially harmful electromagnetic (EM) field proximate to an EM sensitive device.

### BACKGROUND OF THE EMBODIMENTS

Glow-in-the-dark products, which are dependent on photoluminescence, have commercially existed for some time. Two versions of photoluminescent products exist, which can be characterized as active or passive. Active products are often integrated into powered devices, such as TV screens or florescent light bulbs. Passive products, which are those typically considered glow-in-the-dark products, are not generally integrated and essential components of an electronic device or apparatus. These passive photoluminescent products are typically utilized in novelty, promotional products, and toys. That is, the glow-in-the-dark properties of these products are primarily aesthetic in nature and add an aesthetic “wow” factor to different themselves from competition products lacking the “glow-in-the dark” properties.

From a scientific or material-based perspective, phosphors are the main ingredient in glow-in-the-dark or photoluminescent products. When energized, phosphors emit or discharge energy (or light). Energizing, which can also be referred to as charging, involves striking the phosphor with packets of energy, which have frequencies in or near the visible light spectrum. Different phosphors are energized by different frequencies. The energy discharged by phosphors also have a characteristic frequency, which when discharges are in the visible light portion of the electromagnetic (EM) spectrum exhibit a characteristic color consistent with the discharge frequency. Different emission colors are able to be generated by selecting various phosphors. White light, for example, is often produced through a mixture of different phosphors.

Phosphors present in glow-in-the-dark products are often contained in a set of powders, which are mixed into a transparent or semitransparent base medium, such as a silicone or plastic medium. The base medium is often in a liquid state when the phosphors or phosphor powder are intermixed. The phosphor infused liquid is processed to produce a solid glow-in-the-dark” end product. For example, a silicone base medium can be cured and molded to create a phosphor inclusive glow-in-the dark product. In another example, the base medium can be a paint, which is applied to a surface to dry, to create an item with a glow-in-the dark exterior.

A sub-focus of the disclosure concerns innovative utilizations (beyond the typical aesthetic “wow” factor) of photoluminescent food grade silicone components. A food grade silicone product is one that has been certificated safe for consumption, which can even be integrated in food processing. Food grade silicone products expressly lack fillers that are potentially harmful to humans. For example, if a baby or child places a food grade silicone product in their mouth (without improperly swallowing products not designed for consumption) no harm will result. Thus, it can be beneficial for basic safety concerns to utilize food grade silicone products, such as a photoluminescent bead.

There is a need for passive, photoluminescent products that leverage unique photoluminescent characteristics in novel ways to generally enhance safety when utilized.

### REVIEW OF RELATED TECHNOLOGY

U.S. Pat. No. 5,477,433 A relates to an illuminated necklace. Specifically, an illuminated necklace that includes a metallic chain separated into two chain portions. One end of each portion is connected to a pendant that includes an illuminated element, such as a lamp or LED. The other end of each portion is connected to a clasp component that includes a power source.

U.S. Pat. No. 6,296,364 relates to a lighted bead necklace. Specifically, a light-emitting beaded necklace for ornamental decoration that has a set of ornamental beads that each define opposed slots for receiving the beads on an elongate thread. At least one light source is enclosed within one of the beads. The elongated thread extends through the opposed slots of the beads in sequence and distal ends connect together to define a looped article of wearing apparel.

U.S. Pat. No. 8,021,159 relates to a string math manipulative system and method. Specifically, a string math manipulative system and method include a series of a particular number of holed objects threaded on strings. The holed objects comprise one or more variations in color and/or shape and/or material, with the variations configured to represent math facts.

U.S. Publication No 20100291409A1 relates to a method for making a photoluminescent article. A method makes products that glow in the dark, i.e., photoluminescent products, by coating such products with a photoluminescent pigment or ink, or with a plastic material containing the desired photoluminescent compound. Articles which are principally plastic, or having a plastic or partially plastic outer shell or covering can incorporate the photoluminescent pigment or ink directly within the plastic material itself. Photoluminescent products are also disclosed, which may also incorporate reflective material.

U.S. Publication No 20210015084A1 relates to a live bate rig. This reference describes a method and apparatus for a fishing bait line for fishing. The fishing bait line has a main line. The main line has a first end, a second end and a middle portion. A first barrel swivel is coupled to the first end of the main line. A clip swivel is coupled to the second end of the main line. A second barrel swivel is coupled to the middle portion of the main line. One or more glow in the dark beads are coupled substantially near the middle portion of the main line. A glow in the dark chum cylinder coupled to middle portion of the main line.

Foreign (Chinese) Patent No CN301392642S is directed to a silicone necklace. The purpose of the design product is an ornament worn on the human body.

Various craft-based items and disclosures, such as those constructed using glow-in-the-dark beads, exist in the art. However, their purpose and utilizations are substantially different from the present disclosure, as the other inventions fail to leverage the unique characteristics of passive photoluminescent products taught by the present disclosure.

### SUMMARY OF THE EMBODIMENTS

Aspects of the innovation utilize characteristics of passive photoluminescent components in non-aesthetically motivated ways. For example, one or more characteristics, such as discharge duration, thermal discharges, and light discharges that do not generate a potentially harmful electromagnetic (EM) field proximate to an EM sensitive device, are leveraged to enhance safety. In embodiments, the passive photoluminescent component is a set of beads, such as those made of food grade silicone. In embodiments, the passive photoluminescent component can be part of a decorative accessory for hair, such as being integrated into braids, locs, twists, etc.

One aspect of the disclosure is for an electronic light emitting system with a system integrated photoluminescent component. The electronic light emitting system includes an electric emitter (e.g., bulb), an actuator (e.g., a light switch), a power source (e.g., AC or DC power), and a conductive pathway (e.g., wires or traces connecting system components). The electric emitter produces a light emission when active. The actuator has an on and off state. The conductive pathway conveys current to the electric emitter from the power source when the actuator is in the on state and when the electronic emitter is active. When the electronic light emitting system is active and the electric emitter is emitting light, electrons flow across the conductive pathway and a responsive electromagnetic field is generated. When the light emitting system is inactive and the electronic emitter is not emitting light, current does not flow along the conductive pathway and no responsive electromagnetic field is generated. The photoluminescent component is charged by the light emitted from the electric emitter. The photoluminescent component discharges light for a duration after the electronic emitter is changed from the active to an inactive state. The photoluminescent emitter is not connected to the conductive pathway and does not produce an electromagnetic field when discharging light. The discharging of light via the photoluminescent component assists humans for the duration in a situation where an environment is overly dark due to the electric emitter being in the inactive state. The fact that the photoelectronic component does not produce an EM field permits it to be placed near or on EM sensitive components. In embodiments, the photoluminescent component improves safety by (1) illuminating an egress pathway; (2) assisting with reactivating the electronic light emitting system; and (3) highlighting a potentially harmful object in the dark. In one embodiment, a relative temperature of the harmful object can be visually discerned from a color of a thermochromic component. The color changing component, which is illuminated by discharges from the photoluminescent component, thus places a viewer on notice of temperature related harm that is to be avoided, which would be otherwise obscured by the overly dark conditions. In one embodiment, multiple different photoluminescent components, each having a different discharge duration, can be used, which permits a viewer to discern a range of time for which the electronic light emitting system has been inactive.

Another aspect of the disclosure is an illumination system including an electromagnetic (EM) sensitive component and a photoluminescent component. The photoluminescent component is proximately positioned to the EM sensitive component. Proximately positioned is within five inches of a position of the electromagnetic sensitive component. When charged the photoluminescent component provides a level of illumination to the EM sensitive component. The level of illumination is greater than or equal to an equivalent interfering level of illumination able to be generated by an electrical lighting system having an emitter located where the photoluminescent component is located. The interfering level is a level at which an EM field is generated by the electronic lighting system that is harmful to operation of the electromagnetic sensitive component.

Another aspect of the disclosure is directed to an illumination system including a visual message and a first and second photoluminescent components. The visual message is positioned in an environment within which an electronic light emitting system having an on and an off state exists. The visual message indicates a first duration and a second duration to a viewer. When in the off state, the environment is an overly dark environment within which the viewer is unable to easily read the visual message without supplemental illumination. The first photoluminescent component is configured to be charged by emissions from the electronic light emitting system when in the on state. The first photoluminescent component discharges light at a level sufficient to provide supplemental illumination enabling the visual message to be read by the viewer in the overly dark environment. From a time that the electronic light emitting system transitions from the on to the off state, the first photoluminescent is configured to discharge light for discharge duration within ten percent of the first duration. The second photoluminescent component is charged by emissions from the electronic light emitting system when in the on state. The second photoluminescent component discharges light at a level sufficient to provide the supplemental illumination enabling the visual message to be read by the viewer in the overly dark environment. From a time that the electronic light emitting system transitions from the on to the off state, the second photoluminescent is configured to discharge light for discharge duration within ten percent of the second duration.

Yet another aspect of the disclosure provides for an illumination system including a visual message and a photoluminescent component. The visual message is positioned in an environment within which an electronic light emitting system having an on and an off state exists. The visual message is positioned on a harmful object and provides a warning to a viewer that draws attention to the harmful object. When in the off state, the environment is an overly dark environment within which the viewer has a first likelihood of at least one of: taking an action where the harmful object causes harm to the viewer; and taking an action where the viewer causes harm to the harmful object. The photoluminescent component is positioned on the harmful object. The photoluminescent component is charged by emissions from the electronic light emitting system when in the on state. The photoluminescent component discharges light at a level sufficient to provide supplemental illumination, which is sufficient to draw the viewer's attention to the harmful object when in the overly dark environment within which the viewer has a second likelihood of at least one of: taking an action where the harmful object causes harm to the viewer; and taking an action where the viewer causes harm to the harmful object. The second likelihood is at most half of the first likelihood.

As previously noted, inclusion of the photoluminescent component enhances safety. Various safety categories applicable to the disclosure include, for example, emergency preparedness, nighttime visibility, day/nighttime sports and activity safety, pet safety, camping and hiking safety, water safety, threshold traversal (e.g., emergency exit traversal, stairway navigation, and the like), car safety, construction and hazard area safety, and child safety. In subsequent embodiments, glow-in-the-dark beads are utilized as a specific example for a photoluminescent component. It should be understood that the noted shape is one of many and substitutions for “glow-in-the-dark beads” are contemplated, such that the substitutions, especially those of shape and composition, are within the definitional scope of the photoluminescent component.

To elaborate by example, glow-in-the-dark beads can be kept in a designated emergency kit or bag. They can be easily located in the dark and used to mark pathways or important items during power outages or emergencies. In one embodiment, glow-in-the-dark beads are attached to clothing, accessories, or equipment such as backpacks, jackets, or helmets. The glowing beads increase visibility in low-light conditions, making it easier for others to spot you. In another embodiment, participants in nighttime sports or activities like cycling, running, or walking, can add glow-in-the-dark beads to your gear. They can be attached to shoelaces, armbands, or equipment, providing added visibility to yourself and others around you. In a contemplated embodiment, glow-in-the-dark beads are threaded onto your pet's collar or harness. This helps in locating them at night and makes them more visible to motorists and other people, reducing the risk of accidents. In still another embodiment, glow-in-the-dark beads are used to mark trails, tent lines, or campsite boundaries. They can serve as visual markers, especially in areas with limited lighting. In one embodiment, glow-in-the-dark beads are attached to life jackets, flotation devices, or paddles for enhanced visibility during nighttime boating, swimming, or water activities. In one embodiment, glow-in-the-dark beads are attached to the edges of steps, staircases, or emergency exit signs. They can guide people in finding their way and avoiding potential hazards during power failures or low-light situations. In another embodiment, dangerous or restricted areas in construction sites, factories, or warehouses are marked off by using glow-in-the-dark beads as warning signs. They act as a visual reminder to stay away from hazardous zones. In still another embodiment, glow-in-the-dark beads are used as zipper pulls on car emergency kits or attach them to car seats, steering wheel covers, or rearview mirrors. They can aid visibility during nighttime breakdowns or emergencies. In one embodiment, glow-in-the-dark beads are sewn or attached to backpacks, jackets, or school supplies. This helps children remain visible when walking to and from school in dimly lit areas or during evening activities. In one embodiment, glow-in-the-dark beads can be utilized as a hair accessory, often referred to as beaded braids, filigree tubes, dreadlock cuffs, and dreadlock beads. Usages of glow-in-the-dark braided beads enhance safety and provide for a unique means of quick identification in low-light crowded areas. In embodiments, use of braided beads is not limited to humans, but can also be applied to pets, wigs, dolls, and the like.

In one embodiment related to improved electronic device safety, leverages the fact that a passive photoluminescent object does not generate a potentially harmful EM field, which is significant when placed proximate to an EM sensitive device. That is, disclosed photoluminescent products provide discharge lighting while ensuring no interference or electric charge exists, which can damage electronics' functionality. In embodiments, placement of passive photoluminescent components occurs in a manner that avoids obstructing or obscuring critical areas of components/circuits of an electric device. A set of uses proximate to EM sensitive components include, but are not limited to: glow-in-the-dark circuit board art, button and control accents, case embellishments, wire organization and identification, indicator lights, glow-in-the-dark display elements, themed electronic decorations, custom glow-in-the-dark power switch.

To elaborate assuming the selected photoluminescent component is a glow-in-the-dark bead, in one example glow-in-the-dark beads are used to create artistic patterns or designs on the surface of a circuit board. This can add a cool visual effect when the electronics are powered off and provide an interesting aesthetic when viewed in a dimly lit environment. In another embodiment, if you have physical buttons or controls on your electronic device, you can enhance their appearance by adding glow-in-the-dark beads around them. This can make the buttons easier to locate in the dark and give your device a distinctive look. In another, one can apply glow-in-the-dark beads to the outer surface of the electronics case to create patterns, shapes, or messages. This can make your device stand out and be easily recognizable in low-light situations. In one contemplated embodiment, one can use different colored glow-in-the-dark beads to identify and organize wires or cables in your electronic projects. This can be especially useful in complex setups where multiple wires need to be managed. In an embodiment, instead of using conventional indicator lights, you can place small glow-in-the-dark beads near status LEDs. When the device is powered off, these beads can provide a soft glow to indicate the device's location or presence. In another configuration, if your electronic project has a display, glow-in-the-dark beads are used to create interesting designs around the screen. This can be particularly appealing for devices that have an always-on display or a clock function. A clock function, expressing relative time from a charging point, can be enhanced by use of different discharge durations from diverse glow-in-the-dark beads. In one embodiment custom electronic gadgets are built for specific events or themes, such as parties, holidays, or festivals. Incorporating glow-in-the-dark beads can add a fun and immersive element to the overall experience. In still another embodiment, a custom power switch is created with glow-in-the-dark beads to make it easy to find and operate the device, even in the dark.

In one embodiment, the photoluminescent component can be a component of a device that has therapeutic qualities. For example, the photoluminescent component can be integrated within a fidget spinner, a fidget cube, a stress ball, a pop-it fidget device, and the like.

### BRIEF DESCRIPTION OF THE DRAWINGS

FIG. 1A and 1B show an electronic light emitting system with system integrated photoluminescent component 118, in accordance with aspects of the disclosure.

FIG. 2A is a diagram illustrating an EM sensitive component with a proximate photoluminescent component, in accordance with aspects of the disclosure.

FIG. 2B is a diagram illustrating use of a set of photoluminescent components with differing discharge durations, in accordance with aspects of the disclosure.

FIG. 3A is a diagram illustrating potentially harmful objects made safer through use of a photoluminescent component and/or a thermochromic component, in accordance with aspects of the disclosure.

FIG. 3B is a diagram illustrating use of a photoluminescent component in conjunction with a circuit breaker or other component needing service to activate an inactive electoral lighting system, in accordance with aspects of the disclosure.

FIG. 4 is a flow chart illustrating safety enhancements enabled via one or more photoluminescent components, in accordance with aspects of the disclosure.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, an “embodiment” means that a particular feature, structure or characteristic is included in at least one or more manifestations, examples, or implementations of this invention. Furthermore, the particular features, structures or characteristics may be combined in any suitable manner, as would be apparent to a person having ordinary skill in the art. Combinations of features of different embodiments are meant to be within the scope of the invention, without the need for explicitly describing every possible permutation by example. Thus, any of the claimed embodiments can be used in any combination.

The phrase “and/or,” as used herein in the specification and in the claims, should be understood to mean “either or both” of the elements so conjoined, e.g., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements), etc.

As used herein, the word “include,” and its variants, is intended to be non-limiting, such that recitation of items in a list is not to the exclusion of other like items that may also be useful in the compositions and methods of this technology. Similarly, the terms “can” and “may” and their variants are intended to be non-limiting, such that recitation that an embodiment can or may comprise certain elements or features does not exclude other embodiments of the present technology that do not contain those elements or features.

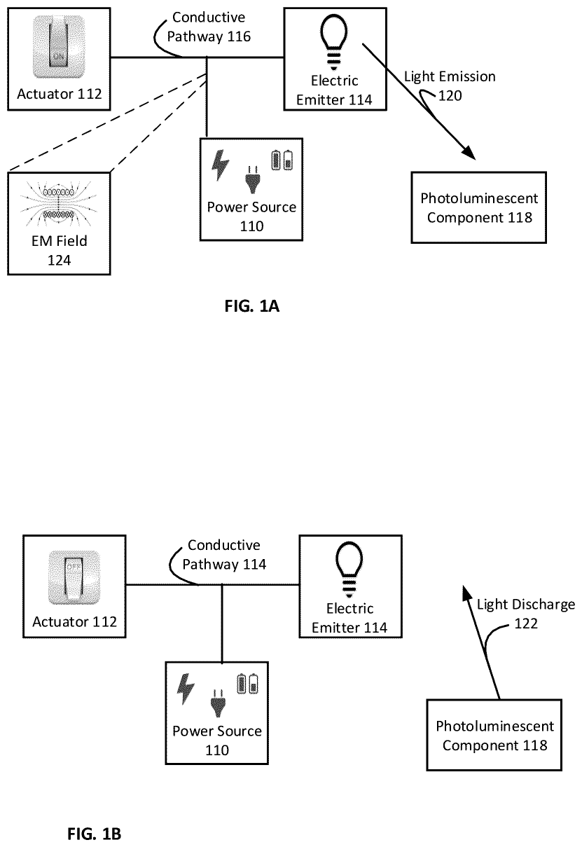

FIG. 1A and 1B show an electronic light emitting system with system integrated photoluminescent component 118, in accordance with aspects of the disclosure. The light emitting system can include an electronic light emitter 114 connected via conductive pathway 114 to an actuator 112, and a power source 110. When active, electrons travel along the conductive pathway, which generates electromagnetic field 124. Light emissions 120 from the electronic emitter 114 charge photoluminescent component 118. When actuator 112 is in an off position, the electronic light emitting system is in an off or non-active state, where no light emissions 120 occur. The photoluminescent component 118 produces a light discharge 122 when the system is otherwise off. The light discharge provides a level of illumination for a duration. The duration is dependent on the discharge characteristics of the photoluminescent component 118. The photoluminescent component 118 is a passive “glow-in-the-dark” component that is not integrated in the electronic light emitting system, such that component 118 is not functionally connected to conductive pathway 114, unlike other system components 110, 112, 114.

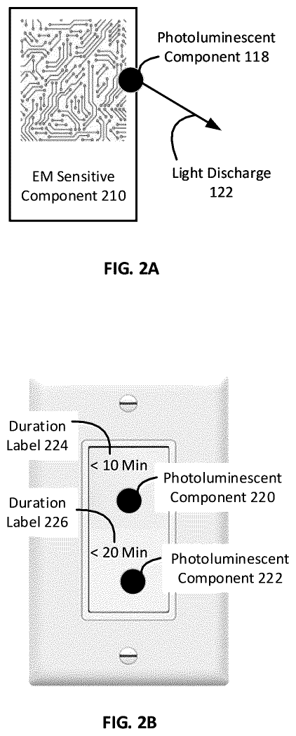

With reference to FIG. 2A, the photoluminescent component 118 may be placed in close proximity to one or more EM sensitive components 210. Because the photoluminescent component 118 does not generate an EM field (such as EM field 124), light discharges 122 from the photoluminescent component 118 cannot interfere or otherwise disrupt the functioning of the proximate EM sensitive component 210.

With reference to FIG. 2B, embodiments are contemplated where multiple photoluminescent components 118, such as photoluminescent component 220 and photoluminescent component 222, are present, which have been selected for their different discharge durations. Both components 220, 222 are positioned, as shown within a light switch that is an example of actuator 112, to be charged when a related electronic light emitting system is active (e.g., the state of FIG. 1A). In one embodiment, components 220, 222 can be circular shapes, such as being a bead or a half-bead. In one embodiment, components 220, 222 can be silicone products, such as being formed by a food grade silicone material. When the system is inactive, components 220, 222 are illuminated for their characteristic durations. The discharge duration of photoluminescent component 220 is ten (10) minutes, as indicated by duration label 224. The discharge duration of photoluminescent component 222 is twenty (20) minutes, as indicated by duration label 226. The arrangements of FIG. 2B are useful, as an observer is able to perceive whether components 220 and 220 are discharging, especially when located in a dark room. If both components 220, 222 are providing illumination, the observer knows the power-off condition has occurred for ten minutes or less. When component 220 is not illuminating, but component 222 is, the power off condition has occurred between ten and twenty minutes. When neither component 220, 222 is providing illumination, the power off condition has occurred for greater than 20 minutes. Any number of photoluminescent components 118 can be utilized, each tailored for different durations, to provide greater fidelity to the knowledge of how long the power-off state has persisted, which is limited only by an availability of tailoring photoluminescent components 118 for desired discharge durations.

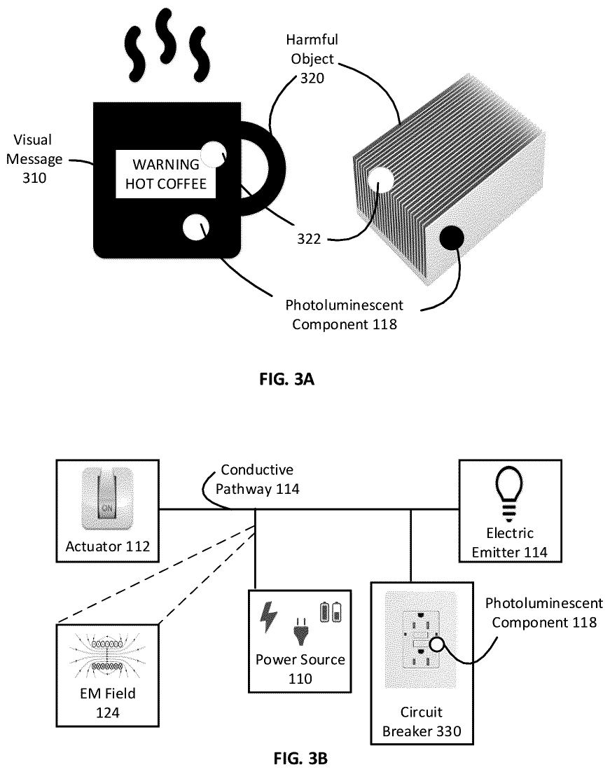

With reference to FIG. 3A, one or more photoluminescent components 118 can be present along with one or more thermochromic components 322. A thermochromic component 322 is one that changes color or becomes invisible/transparent at a particular temperature. These temperatures can be changed by the use and mixture of different thermochromic pigments (or powders) within a base material. In embodiments, a single component having both photoluminescent and thermochromic properties, which is achievable through the addition of selected powders with a base material when in a liquid state, can be used instead of two discrete components 118, 322 as shown in FIG. 3A.

The thermochromic component 322 is used to provide a visually observable indicator that an overly hot, and thereby potentially harmful, object 320 is present in an environment. The environment may be dark, as a related illumination system may be in an off state (FIG. 1B). Such an environment, referred to as an overly dark environment, is one where a human present is provided insufficient lighting to avoid touching, spilling, or otherwise contacting the harmful object 320. A windowless room lacking electrically emitted light (light emission 120) is one example; as is a windowed room at night time.

One or more visual messages 310 may be placed upon or near the harmful object 320, such as a warning message that an object 320 contains hot liquid, such as hot coffee. The message 310 can be illuminated by photoluminescent component 118, so it can be read/perceived in an overly dark environment. In other embodiments, the photoluminescent component 118 (or set thereof) can be shaped, formed, or arranged into the visual message 310. Different characteristic appearances (colors) of the thermochromic component 322 permit an observer to visually identify a relative temperature of the harmful object 320.

In embodiments, the thermochromic (which may or may not have photoluminescent characteristics) component 320 can be helpful in otherwise well-lit environments (such as shown in FIG. 1A). For example, a heat sink, which is one of the harmful objects 320 shown in FIG. 3A, can situationally be too hot to touch without risk of harm to a contacting human. The color of component 322 indicates whether a risk of harm due to exceeding safe ranges of temperature at a given point in time is present or not.

In embodiments, with reference to FIG. 3A, a presence of a photoluminescent component 118 is helpful for safety reasons even without being combined with a thermochromic component 322. For example, a photoluminescent component 118 can be placed on a “glass table” or on a sharp protrusion point (each being a harmful object 320 or a potentially harmful one) of a piece of furniture as a safety precaution. When an environment is in an overly dark one, a human is likely to inadvertently be harmed by striking the glass table, which may shatter, or to be impaled by the protrusion point. Inclusion of the photoluminescent component 118 (and presenting an additional visual message 310) enhances safety making potential harm far less likely. In other configurations, other potentially harmful objects 320, such as a sleeping pet that could be harmed if stepped on, can be somewhat illuminated through the inclusion of a photoluminescent component 118; positioned in a pet's collar for example. In a further example, a pet, child, or other human can have braided beads, which include photoluminescent component 118, which helps another detect and identify a location of the person having braided beads. In a crowded room, where lights are low and/or unexpectedly shut off, a parent or caregiver can quickly identify a child among a crowd due to a presence and unique illumination afforded by the braided beads integrated with component 118. Any of a variety of hair styles can be utilized, which include braids, locs, twists, etc. In another example, the photoluminescent component 118 can be integrated with a device/object having therapeutic qualities, such as a fidget device (e.g., fidget spinner; fidget cube), stress ball, and the like. The example(s), illustrates that the “harmful object” can be one that is subject to harm in a dark or placed in a likelihood of extra harm due to dark conditions, which is mitigated or corrected by the creative use of photoluminescent component 118.

With reference to FIG. 3B, a photoluminescent component 118 can be placed proximate to a problem resolving component of an electronic light emitting system. For example, unexpected surges often trip a circuit breaker 330, which causes a discontinuity in the conductive pathway 110 cutting off various components (emitter 114) from the power source 110. Thus, the system is in a power-off state until the circuit breaker 330 is reset, which removes the intentional discontinuation of the conductive pathway 114. Unfortunately, when the system that is deactivated when the circuit breaker 330 is tripped is in an off state, finding and resetting the circuit breaker in an overly dark environment can be challenging. Moreover, some circuit breakers 330, like those included in bathroom outlets, exist, which humans often are unaware of. Inclusion of photoluminescent component 118 by the circuit breaker 330 resolves this problem, as it inherently highlights (visibly) the component in low-light situations. Even when humans have knowledge of the circuit breaker 330 and the need to reset it, inclusion illumination provided by the proximate photoluminescent component 118 simplifies this task and enhances safety.

In other related situations, a battery powered (one variation of power source 110) light emitting system (e.g., a flashlight) can have a battery component, which is hard to see in a low-light situation. Thus, when a flashlight suddenly goes off, replacing the battery is hard. The battery compartment can be enhanced by a proximate photoluminescent component 118, which provides some additional illumination to facilitate the safe replacement of a battery.

In still another situation, such as that illustrated in FIG. 2B, illuminating an actuator that selectively generates light via one or more photoluminescent components 118 is beneficial to guide a human attempting to re-illuminate an otherwise overly dark environment, such as by activating a light switch.

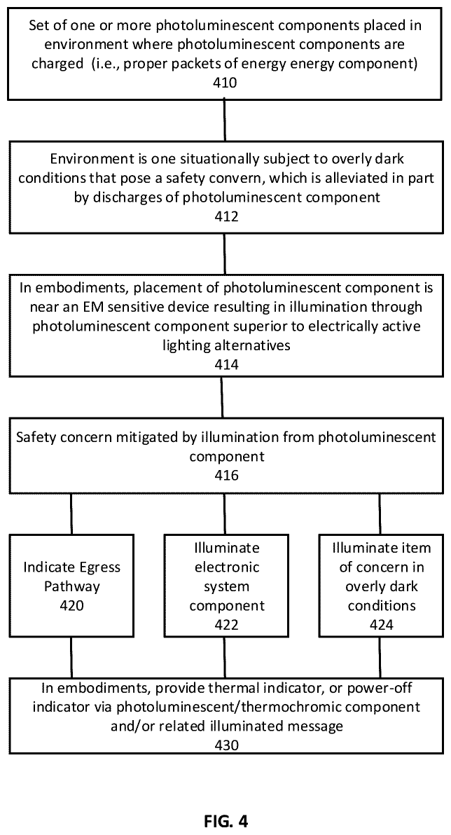

With reference to FIG. 4, a set of one or more photoluminescent components are placed in an environment, as shown by step 410. This environment is one where photoluminescent components are charged when safety concerns are minimal. For example, when an environment is fully illuminated, as in FIG. 1A, due to light emissions 120 there are minimal safety concerns. In this state, photoluminescent component 118 is charged via the light emission 120. Thus, step 410 reflects an environment having two divergent states, where a first (proper lighting state) imposes less safety concerns than a second. When in the first state, the photoluminescent is being energized or charged. It should be appreciated that discharges from component 118 may occur when in a first state of proper lighting. At such a time, the additional lighting provided by component 118 and the accompanying safety improvements (if any) are minimized.

Step 412 elaborates upon this by noting that the environment is one that is situationally subject to overly dark conditions (state 2 of improper lighting), which pose a safety concern. This safety concern is alleviated, at least in part, by discharges of photoluminescent component 118, as previously detailed. For example, use of glow-in-the-dark braided beads woven into a child's hair can alleviate the safety concerns of a parent not being able to locate the child in overly dark conditions.

In step 414, which occurs in embodiments, the photoluminescent component 118 is placed near an EM sensitive device, which as EM sensitive component 210. This results in the photoluminescent component 118 providing illumination (i.e., light discharge 122) in a manner that is not harmful to the EM sensitive component 210. Thus, illumination superior to that produced by an electrically active lighting alternative (which generates an EM field as do all such alternatives) is provided by photoluminescent component 118.

Step 416 indicates that safety concerns are mitigated by illumination from the photoluminescent component 118. Although three different examples (steps 420, 422, and 424) are illustrated in FIG. 4, other situations are contemplated consistent with this disclosure.

In step 420, the safety concern mitigated involves providing an indication of an egress pathway. For example, finding a doorknob, an emergency exit, or navigating a staircase in overly dark conditions is mitigated by illumination provided.

In step 422, an electronic device system or component thereof is illuminated. This illumination aids a human in servicing the electronic device system despite otherwise overly dark conditions. The electronic device system can be one that provides illumination when activated. For example, illumination of a light switch or a circuit breaker via the photoluminescent component “repairs” the light generating system so that it may once again generate light.

In step 424, the safety concern mitigated involves an item of concern in overly dark conditions. This item can be a harmful one (see FIG. 3A) that may harm a person inadvertently or improperly making contact. Adding illumination via component 118 appreciably lessens this potential harm. Further, an item of concern can be one that is not to be improperly handled as the item itself may otherwise be harmed. For example, the item of concern can be a sleeping pet or a child, who is could be easily stepped on in overly dark conditions. Similarly, expensive glassware could be harmed if knocked over by a person stumbling around in the dark and is therefore a potential item of concern as expressed in step 424.

In step 430, a terminal indicator (e.g., a thermochromic component) can be utilized/coupled with the photoluminescent component 118, such as discussed with reference to FIG. 3A. Similarly, a power off duration indicator (e.g., a set of photoluminescent components with varying discharge durations) can be integrated to provide additional and significant information regarding a time period for which overly dark conditions have persisted. For instance, in environments where short-term power disruptions are moderately normal, an inhabitant in an overly dark environment may choose to stay put, until it becomes evident that steps are to be taken to restore power, such as tripping a fuse. In such an instance, a person may opt to only navigate the dark towards the circuit breaker after the discharge duration of one or more components 118 expires. In a different example, a component 110 functioning as a duration indicator may be placed on a lightbulb, which should not be touched, as it will be inherently hot, as long as the component 118 is still discharging (i.e., producing light by glowing in the dark). The different embodiment directed to a lightbulb with an attached photoluminescent component 118 illustrates how functions detailed for thermochromic components can be situationally replaced and/or supplemented by the duration characteristic of the photoluminescent component 118.

In many embodiments, the characteristic light emission (color variable based on selection of phosphors) from component 118 may inherently serve as a message, which mitigates a safety concern. In other embodiments, presentation of a message, symbol, icon, etc., which is readable via illumination from component 118 is helpful. In such a configuration, the message itself may not be glow-in-the-dark but is sufficiently illuminated by component 118 so that it may be read. In another embodiment, component 118 can be formed or shaped to present a glow-in-the-dark message or graphic. In one embodiment, a set of circles, dots, beads, and the like that are glow-in-the-dark can be arranged to form a message and/or graphic.

The specific examples illustrated in FIG. 1A-4 are not intended as limiting, but as illustrative examples of the leveraging of photoluminescent components 118 and their characteristics as detailed herein. For example, various categories and examples have been presented within the “summary” section, which are of course within scope of this disclosure; as are other related concepts readily apparent to one of ordinary skill having been presented the concepts detailed herein, which are otherwise absent from the state of the art at the time of filing.

As used herein, a power source 110 is a source of electrical power. The power source 110 may be an AC or DC power source depending on implementation choices.

An actuator 112 is a selectable switch or component able to adjust an light emitting system between having two or more states, one being an active or “on” state; one being an inactive of “off” state. In one example, the actuator 112 can be a light switch. In another example, the actuator 112 can be a flashlight button.

An electric emitter 114 is a light emitting component, which derives its power from power source 110. The electric emitter 114 thus relies on current being conveyed via conductive pathway 114. Electric emitter 114 may energize or charge the photoluminescent component 118. In embodiments, the electric emitter 114 can be a light bulb, a light tube, and the like. Light emitter 114 can utilize incandescence, florescence, LED-based emissions, and the like.

A conductive pathway 116 represents a pathway over which current flows. A conductive pathway 116 can include household electrical wires and related components. In another embodiment, the conductive pathways can include an interconnected set of sockets and wires connecting a flashlight bulb to a power source. Traces within silicon circuity are considered a conductive pathway 116 in embodiments. Further, power transmissions occurring through inductive charging, such as via phone charging pads and other “wireless charging” mechanisms are considered conductive pathways 114 within scope of the present disclosure. Regardless of specifics, interruption of electric charge over the conductive pathway, such as when the actuator 112 is in an off state, results in interruption of current being provided to emitter 114. Thus, some “wireless power” conveyances, especially those involving significant energy stores that buffer power, are not considered within scope of the disclosure's definition for a conductive pathway as is evident from the usage throughout the disclosure.

A photoluminescent component 118 is a phosphor containing component that absorbs energy and thereafter discharges energy for a duration. The energy absorbed and discharged by the photoluminescent component 118 is restricted to energy within the visible light range. Thus, emissions/discharges in the UV and infrared frequency range are outside the definitional scope of the photoluminescent component 118.

In one embodiment, the photoluminescent component 118 can be realized by a set of beads, half-beads, orbs, and the like. In other embodiments, the photoluminescent component 118 can be in a non-spherical shape. Various materials can be utilized to form the photoluminescent component 118. In one embodiment, component 118 can be formed using a silicone base material.

In a contemplated embodiment, the photoluminescent component 118 can be a set of one or more soft, food grade silicone, textured, multi-use beads. Such beads are notable as being lightweight, soft, squishy, and squeezy. These food grade silicone beads have a noted ability to emit light in the dark or low light conditions from the use of both sunlight and/or artificial lighting. The noted beads may be marketed as small decorative accessory able to function in the use of; hair, craft, safety, jewelry, educational and electronic accessories; to name a few.

A light emission 120 refers to the energy, which is within the visible light spectrum, generated by electric emitter 114. Light emissions 120 are often designated as generating soft or clear lighting. Light emissions 120 may be in various colors in embodiments. Importantly, the light emissions 120 must emit energy in a frequency range suitable for charging the photoluminescent component 118.

A light discharge 122 refers to the energy, which is within the visible light spectrum, generated by the photoluminescent component 118.

An EM field 124 refers to an electromagnetic field. The EM field 124 is always present when current is conveyed over the conductive pathway 114.

An EM sensitive component 210 is a device, circuit, or part thereof that is liable to malfunction when exposed to an external EM field. Often malfunctions or disruptions are referred to as interface.

Labels 224 and 226 refer to a set of one or more words and/or graphics that provides a useful indication relevant to a discharge duration of a related photoluminescent component 118. That is, the label 224 is related to a discharge time of an associated component 118, where components having different discharge durations are likely to have different associated labels 224 and 226.

A visual message 310 refers to a set of one or more words and/or graphics that convey a meaning associated with a presence or absence of illumination from a corresponding set of one or more photoluminescent components 118. In one embodiment, the visual message 310 can be associated with a harmful object. Further, the visual message 310 may convey or imply an action to be taken with regard to a harmful object in the presence of overly dark conditions.

A harmful object 320 refers to an object, being, or garment that situationally poses a risk to a proximate human or itself. Greater risk is present or more likely to occur in overly dark conditions; contrasted with conditions in which sufficient light is present.

A thermochromic component 322 is a component subject to a change color due to a change in temperature. A mood ring is an example of a thermochromic component 322.

The block diagrams in the Figures illustrate the architecture, functionality, and operation of possible implementations of systems, methods, and apparatuses according to various embodiments of the present invention. In this regard, each block in the block diagrams may represent a module, a segment, or a portion implementing the specified function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An electronic light emitting system with system integrated photoluminescent component comprising:
an electric emitter that produces a light emission when active;
an actuator having an on and an off state;
a power source;
a conductive pathway conveying current to the electric emitter from the power source when the actuator is in the on state and when the electronic emitter is active
wherein when the electronic light emitting system is active and the electric emitter is emitting light, electrons flow across the conductive pathway and a responsive electromagnetic field is generated, wherein when the light emitting system is inactive and the electronic emitter is not emitting light, current does not flow along the conductive pathway and no responsive electromagnetic field is generated; and
a photoluminescent component configured to be charged by the light emitted from the electric emitter, wherein the photoluminescent component discharges light for a duration after the electronic emitter is changed state from the active to an inactive state, wherein when photoluminescent emitter is not connected to the conductive pathway and does not produce an electromagnetic field when discharging light, wherein the discharging of light via the photoluminescent component assists humans for the duration in a situation where an environment is overly dark due to the electric emitter being in the inactive state, wherein the humans are assisted by the discharged light for the duration by at least one of:
having an egress pathway from the overly dark environment being indicated by the discharged light, such that the egress would be less visible and more challenging in absence of the discharged light;
illuminating a component of the electronic light emitting system that needs to be serviced by the human to cause the electric emitter to emit light again; and
illuminating an environmental item of concern, referred to as a harmful object, within the overly dark environment to prevent the human from causing harm to the environmental item or themselves due to the environment being overly dark.

2. The system of claim 1, wherein humans are assisted for the duration by having the egress pathway from the overly dark environment being indicated by the discharged light, such that the egress would be less visible and more challenging in absence of the discharged light.

3. The system of claim 1, wherein humans are assisted for the duration by illuminating the component of the electronic light emitting system that needs to be serviced by the human to cause the electric emitter to emit light again.

4. The system of claim 1, wherein humans are assisted for the duration by illuminating the environmental item of concern within the overly dark environment to prevent the human from causing harm to the environmental item or themselves due to the environment being overly dark.

5. The system of claim 1, wherein the photoluminescent component is positioned proximate to an EM sensitive component such that the discharged light illuminates the EM sensitive component without generating an electromagnetic field, wherein proximate refers to being within five inches of the EM sensitive component.

6. The system of claim 1, wherein the photoluminescent component is comprised of a set of one or more beads.

7. The system of claim 6, wherein the set of beads are composed of textured, soft, squishy, food grade silicone.

8. The system of claim 1, wherein the discharge of light forms a visual message, said visual message being at least one of a set of words and a human identifiable graphic.

9. The system of claim 8, wherein the visual message is related and positioned proximate to at least one of a battery compartment of the electronic light emitting system, the actuator, and a circuit breaker electrically connected to the conductive pathway.

10. The system of claim 1, wherein the photoluminescent component a first photoluminescent component, wherein the system further comprises a second photoluminescent component, wherein the first photoluminescent component discharges light for a first duration, wherein a second photoluminescent component discharges light for a second duration that is longer than the first duration, wherein inclusion of the first and second photoluminescent components within the system is expressly to permit an observer to know whether the emissions from the electric emitter have been deactivated for a time less than the first duration, for a time greater than the first duration but less than the second duration, or for a time greater than the second duration.

11. The system of claim 4, further comprising:
a thermochromic component that provides a color-based indicator related to a current temperature of the harmful object.

12. An illumination system comprising:
an electromagnetic sensitive component; and
a photoluminescent component proximately positioned to the electromagnetic sensitive component, wherein proximately positioned is within five inches of a position of the electromagnetic sensitive component, wherein when charged the photoluminescent component provides a level of illumination to the electromagnetic sensitive component, wherein the level of illumination is greater than or equal to an equivalent interfering level of illumination able to be generated by an electrical lighting system, wherein the interfering level is a level at which an EM field is generated by the electronic lighting system that is harmful to operation of the electromagnetic sensitive component.

13. The system of claim 12, further comprising:
a visual message positioned in an environment within which an electronic light emitting system having an on and an off state exists, wherein the visual message indicates a first duration and a second duration to a viewer, wherein when in the off state, the environment is an overly dark environment within which the viewer is unable to easily read the visual message without supplemental illumination;
a first photoluminescent component configured to be charged by emissions from the electronic light emitting system when in the on state, wherein the first photoluminescent component discharges light at a level sufficient to provide the supplemental illumination enabling the visual message to be read by the viewer in the overly dark environment, wherein from a time that the electronic light emitting system transitions from the on to the off state, the first photoluminescent is configured to discharge light for discharge duration within ten percent of the first duration; and
a second photoluminescent component configured to be charged by emissions from the electronic light emitting system when in the on state, wherein the second photoluminescent component discharges light at a level sufficient to provide the supplemental illumination enabling the visual message to be read by the viewer in the overly dark environment, wherein from a time that the electronic light emitting system transitions from the on to the off state, the second photoluminescent is configured to discharge light for discharge duration within ten percent of the second duration, wherein at least one of the first photoluminescent component and the second photoluminescent component is the photoluminescent component.

14. The system of claim 12, further comprising:
a visual message positioned in an environment within which an electronic light emitting system having an on and an off state exists, wherein the visual message is positioned on a harmful object and provides a warning to a viewer that draws attention to the harmful object, wherein when in the off state, the environment is an overly dark environment within which the viewer has a first likelihood of at least one of:
taking an action where the harmful object causes harm to the viewer; and
taking an action where the viewer causes harm to the harmful object,
wherein the photoluminescent component is positioned on the harmful object, wherein said photoluminescent component is configured to be charged by emissions from the electronic light emitting system when in the on state, wherein the photoluminescent component discharges light at a level sufficient to provide supplemental illumination, which is sufficient to draw the viewer's attention to the harmful object when in the overly dark environment within which the viewer has a second likelihood of at least one of:
taking an action where the harmful object causes harm to the viewer; and
taking an action where the viewer causes harm to the harmful object,
wherein the second likelihood is at most half of the first likelihood.

15. An illumination system comprising:
a visual message positioned in an environment within which an electronic light emitting system having an on and an off state exists, wherein the visual message indicates a first duration and a second duration to a viewer, wherein when in the off state, the environment is an overly dark environment within which the viewer is unable to easily read the visual message without supplemental illumination;
a first photoluminescent component configured to be charged by emissions from the electronic light emitting system when in the on state, wherein the first photoluminescent component discharges light at a level sufficient to provide the supplemental illumination enabling the visual message to be read by the viewer in the overly dark environment, wherein from a time that the electronic light emitting system transitions from the on to the off state, the first photoluminescent is configured to discharge light for discharge duration within ten percent of the first duration; and
a second photoluminescent component configured to be charged by emissions from the electronic light emitting system when in the on state, wherein the second photoluminescent component discharges light at a level sufficient to provide the supplemental illumination enabling the visual message to be read by the viewer in the overly dark environment, wherein from a time that the electronic light emitting system transitions from the on to the off state, the second photoluminescent is configured to discharge light for discharge duration within ten percent of the second duration.

16. The system of claim 15, further comprising:
an electromagnetic sensitive component
wherein at least one of the first and second photoluminescent components, which is referred to as the proximate emitting component, are proximately positioned to the electromagnetic sensitive component, wherein proximately positioned is within five inches of a position of the electromagnetic sensitive component, wherein when charged the proximate emitting component provides a level of illumination to the electromagnetic sensitive component, wherein the level of illumination is greater than or equal to an equivalent interfering level of illumination able to be generated by an electrical lighting system, wherein the interfering level is a level at which an EM field is generated by the electrical lighting system that is harmful to operation of the electromagnetic sensitive component.

17. The system of claim 16, wherein at least one of:
the first photoluminescent component and
the second photoluminescent component
referred to as the object attached component, is attached to a harmful object, wherein the visual message is positioned on the harmful object and provides a warning to a viewer that draws attention to the harmful object, wherein when in the off state, the environment is the overly dark environment within which the viewer has a first likelihood of at least one of:
taking an action where the harmful object causes harm to the viewer; and
taking an action where the viewer causes harm to the harmful object,
wherein the object attached component discharges light at a level sufficient to provide supplemental illumination, which is sufficient to draw the viewer's attention to the harmful object when in the overly dark environment within which the viewer has a second likelihood of at least one of:
taking an action where the harmful object causes harm to the viewer; and
taking an action where the viewer causes harm to the harmful object,
wherein the second likelihood is at most half of the first likelihood.

18. An illumination system comprising:
a visual message positioned in an environment within which an electronic light emitting system having an on and an off state exists, wherein the visual message is positioned on a harmful object and provides a warning to a viewer that draws attention to the harmful object, wherein when in the off state, the environment is an overly dark environment within which the viewer has a first likelihood of at least one of:
taking an action where the harmful object causes harm to the viewer; and
taking an action where the viewer causes harm to the harmful object; and
a photoluminescent component positioned on the harmful object, wherein said photoluminescent component is configured to be charged by emissions from the electronic light emitting system when in the on state, wherein the first photoluminescent component discharges light at a level sufficient to provide supplemental illumination, which is sufficient to draw the viewer's attention to the harmful object when in the overly dark environment within which the viewer has a second likelihood of at least one of:
taking an action where the harmful object causes harm to the viewer; and
taking an action where the viewer causes harm to the harmful object,
wherein the second likelihood is at most half of the first likelihood.

19. The illumination system of claim 18, wherein the action that the viewer has the first likelihood and second likelihood to take is:
taking an action where the harmful object causes harm to the viewer due at least in part to the harmful object being at a harmful temperature level, said system further comprising:
a thermochromic component positioned on the harmful object, wherein the thermochromic component is configured to change color responsive to temperature such that a first color of the thermochromic component is presented to the viewer when a temperature of the harmful object is less than the harmful temperature level and a second color of the thermochromic component is presented to the viewer when the temperature of the harmful object is the harmful temperature level or greater, wherein the thermal chromic component is illuminated by discharges of the photoluminescent component in the overly dark environment so that the viewer is able to perceive whether the thermochromic component is either the first color or the second color.

20. The system of claim 18, wherein the harmful object is an electromagnetic sensitive component, wherein when charged the photoluminescent component provides a level of illumination to the electromagnetic sensitive component in the overly dark environment, wherein the level of illumination is greater than or equal to an equivalent interfering level of illumination able to be generated by an electrical lighting system having a light emitter located at the position of the photoluminescent component, wherein the interfering level is a level at which an EM field is generated by the electrical lighting system that is harmful to operation of the electromagnetic sensitive component.
